(19) United States
(12) Patent Application Publication
(10) Pub. No.: US 2026/0125512 A1
(43) Pub. Date: May 7, 2026

(54) WATER SOLUBLE CO-POLYESTER

(71) Applicant: Ester Industries Limited, Uttarakhand (IN)

(72) Inventors: Balasundaram DILLYRAJ, Uttarakhand (IN); Chandrakant Omkar VYAS, Uttarakhand (IN); Gokal KUMAR, Uttarakhand (IN); F. Louis JOSEPH, Uttarakhand (IN); Gaurav OJHA, Uttarakhand (IN); Ravindra Chandra SHARMA, Uttarakhand (IN)

(21) Appl. No.: 18/880,794

(22) PCT Filed: Feb. 16, 2024
(86) PCT No.: PCT/IN2024/050164

§ 371 Date: Jan. 2, 2025

(30) Foreign Application Priority Data
Feb. 17, 2023 (IN) 202311010763

(51) Int. Cl. C08G 63/183; C08G 63/91; C08J 5/18

(52) U.S. Cl. CPC C08G 63/183; C08G 63/916; C08J 5/18; C08J 2367/02

(57) ABSTRACT

The present invention discloses a water soluble co-polyester precursor comprising: (a) at least one dicarboxylic acid or ester thereof; (b) at least one diol; and (c) at least dimethyl sulfoisophthalate (DMSIP) or isophthalic acid sulfonate (SIPA) having a weight percentage in the range of 0 to 20 wt % or 0 to 18% trimellitic anhydride. The water-soluble co-polyester of the present invention has an excellent solubility in hot water at low-temperature. The water soluble co-polyester precursor can be used in the films or coatings which can be then used to form top coats that exhibit good resistance to scratches and solvents, and improved ink adhesion, improved metallic bonding strength and image quality.

### FIELD OF THE INVENTION

The present invention relates to the field of water-soluble co-polyester. Particularly, the present invention relates to a water-soluble co-polyester having an excellent solubility in hot water at low-temperature. It can be used as an adhesive based on a high glass transition temperature (Tg) and it has better surface tension properties. The films or coatings made by using present invention's co-polyester can be used to form top coats that exhibit good resistance to scratches and solvents, and improved ink adhesion, improved metallic bonding strength and image quality. These features make the co-polyester of the present invention a special grade for flexible packaging especially for pasturisable/retortable liquid packaging.

### BACKGROUND OF THE INVENTION

Aqueous coating compositions of a resinous thermoplastic coating material (clear coat) such as thermoplastic, (meth)acrylic or (meth)acrylic-styrene copolymer in the form of emulsions are well known in the printing industry. In today's world, wherein Climate change and its prevention is one of the sustainable goals of UN it is important that use of organic solvents is restricted and such a product is made for which water can be used as a solvent and the product can be used for various industrial purposes.

For example, a reference is made to Japanese Patent Laid-Open No. Hei9-296100 that discloses an aqueous dispersion of polyester resin obtained by dispersing polyester resin with an acid value of 10 to 40 mg KOH/g and a weight average molecular weight of 9,000 or higher in an aqueous medium, and it is described that a coating film excellent in properties such as processability and solvent resistances can be produced using such an aqueous dispersion.

Similarly, another reference is made to U.S. Pat. No. 5,384,160 that provides a method for depositing an aqueous coating composition onto an ink layer or uninked surface in a printing process.

Yet another reference is made to U.S. Pat. No. 6,818,699 that provides an aqueous dispersion of polyester resin that can be used as a coating agent for a variety of substrates and is capable of forming a high-quality polyester resin coating film with a high adhesion strength, but if the dispersion is stored for a long duration, the molecular weight of the polyester resin tends to be lowered. Therefore, it is probable to cause a problem of deterioration of the properties.

Thus, there continues a need in the art for water soluble co-polyester which has improved properties and can be used in various industries.

### SUMMARY OF THE INVENTION

An object of the present invention is to develop a water-soluble co-polyester with improved surface tension and adhesion.

Another object of the invention is to develop a water-soluble co-polyester based on terephthalic acid, isophthalic acid and aliphatic diols.

Yet another object of the invention is to provide a method of manufacturing the water-soluble co-polyester which can be produced in pellet, flake, powder or liquid form.

Further another object of the invention is to provide water soluble co-polyester having excellent solubility in hot water at low-temperature which can be used as an adhesive and has better surface tension properties.

Another object of the present invention is to provide water soluble co-polyester films or coatings that can be used to form top coats that exhibit good coating composition.

Yet another object of the present invention is to provide a water-soluble co-polyester which can be used as a coating to improve one or more than one surface properties of polyester films. The surface properties that are improved can be selected from but are not limited to improved surface tension, adhesion, printing, metallizing properties and/or glossiness of the film.

Still further object of the present invention is to provide a water-soluble co-polyester that can be used directly as a coating by dissolving it in water without the use of any other organic or inorganic solvent.

Another object of the invention is to provide a water-soluble co-polyester that can be used to form top coats that exhibit good resistance to scratches and solvents, and improved ink adhesion and image quality.

Further another object of the invention is to provide water soluble co-polyester that has increased bond strength and improved dyne values that leads to efficient printing and the printed matter is not wiped off.

The co-polyester of the present invention has improved surface tension, adhesion, bond strength, dyne value, resistance and solubility in water making its applications wide in the field of packaging.

### DETAILED DESCRIPTION

### Definition of Terms

For convenience, before further description of the present invention, certain terms employed in the specification, examples and appended claims are collected here. These definitions should be read in light of the remainder of the disclosure and understood as by a person of skill in the art. Unless defined otherwise, all technical and scientific terms used herein have the same meaning as commonly understood by a person of ordinary skill in the art.

The articles “a”, “an” and “the” are used to refer to one or to more than one (i.e., to at least one) of the grammatical object of the article.

Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

The term “polyester” generally refers to an esterification or reaction product between a polybasic organic acid and a polyol. The present disclosure is particularly directed to a class of polyesters referred to herein as polyethylene terephthalate, in which terephthalic acid serves as the polybasic organic acid, and particularly to PET, but it should be understood that the disclosure is not in any way limited to PET. It covers all polyesters viz PET, PBT, PTT and their allied co-polyesters blends and alloys.

The term “polyester resin” refers to a polyester having a structure obtained through polycondensation of a dicarboxylic acid compound with residues, such as sulfonated hydroxyl terminated ester and sulfonated carboxyl terminated ester with a dihydroxy compound, polycondensation of a hydroxy-carboxylic acid compound, or polycondensation of the above three compounds, etc.

Ratios, concentrations, amounts, and other numerical data are presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, 5 to 40 moles % should be interpreted to include not only the explicitly recited limits of 5 to 40 mole %, but also to include sub-ranges, such as 10 moles % to 30 moles %, 7 moles % to 25 moles %, and so forth, as well as individual amounts, including fractional amounts, within the specified ranges, such as 15.5 mole %, 29.1 mole %, and 12.9 mole %, for example.

The use of the expression “at least” or “at least one” suggests the use of one or more elements or ingredients or quantities, as the use may be in the embodiment of the disclosure to achieve one or more of the desired objects or results.

Any discussion of documents, acts, materials, devices, articles and the like that has been included in this specification is solely for the purpose of providing a context for the disclosure. It is not to be taken as an admission that any or all of these matters form a part of the prior art base or were common general knowledge in the field relevant to the disclosure as it existed anywhere before the priority date of this application.

While considerable emphasis has been placed herein on the particular features of this disclosure, it will be appreciated that various modifications can be made, and that many changes can be made in the preferred embodiments without departing from the principles of the disclosure. These and other modifications in the nature of the disclosure or the preferred embodiments will be apparent to those skilled in the art from the disclosure herein, whereby it is to be distinctly understood that the foregoing descriptive matter is to be interpreted merely as illustrative of the disclosure and not as a limitation.

The water soluble co-polyester precursor of present invention comprising:
a. at least one dicarboxylic acid or ester thereof;
b. at least one diol;
c. At least dimethyl sulfoisophthalate (DMSIP) or/isophthalic acid sulfonate (SIPA) 8 to 20 wt %.

The water soluble co-polyester based on dicarboxylic acid, wherein dicarboxylic acid is selected from aromatic and/or aliphatic acid the group consisting of terephthalic acid, isophthalic acid, 2,6-napthalene dicarboxylic acid, 3,4′-diphenyl ether dicarboxylic acid, hexahydrophthalic acid, 2,7-naphthalenedicarboxylic acid, phthalic acid, 4,4′-methylenebis(benzoic acid), oxalic acid, malonic acid, succinic acid, methylsuccinic acid, glutaric acid, adipic acid, 3-metyhladipic acid, pimelic acid, suberic acid, azelaic acid, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, 1,3-cyclohexanedicarboxylic acid, 1,1-cyclohexanediacetic acid, fumaric acid, maleic acid, and hexahydrophthalic acid.

A diol is a chemical compound containing two hydroxyl groups (—OH groups). An aliphatic diol is also called a glycol. Terms diol or aliphatic diol are used interchangeably in the present invention. The diols of present invention is selected from the group consisting of mono ethylene glycol (MEG), diethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, (cis, trans) 1,4-cyclohexanedimethanol, di(ethylene glycol), tri(ethylene glycol), poly(ethylene ether) glycols, poly(butylene ether) glycols, branched diols, hexane diol or combinations or derivatives thereof.

A water soluble copolyester based on terephthalic acid, isophthalic acid and aliphatic diols is developed wherein the molar proportion of terephthalic acid is at least 80 to 90 mol %, isophthalic acid is at least 10 to 20 mol %, based on the overall acid quantity, the aliphatic diol content at least 80 to 75 mol % of monoethylene glycol, 20 to 25 mol % 1, 6 hexane diol and optionally an additional glycol selected from the group consisting of diethylene glycol up to 20 mol %, 2-Methyl-1,3-propanediol up to 25 mol %, Neopentyl glycol 20 to 30 mol % and mixture thereof to make up 100 mol % of the diol quantity.

A water-soluble co-polyester, wherein the ratio of DIMSIP/SIPA may vary from 0 to 20 wt % or 0 to 18 weight % Trimellitic anhydride.

The water-soluble co-polyester, having a composition of at least 20 to 25 mol % 1, 6 hexane diol based on the diol content, wherein the remainder diol proportion comprise said ethylene glycol.

The water-soluble co-polyester, wherein polymer intrinsic velocity is adjusted in melt polymerization from 0.300 dl/g to 0.500 dl/gm.

The water soluble co-polyester chopped through underwater melt granulator or underwater strand granulator is produced in the form of chips/pellets having melting point of 80-180° C. can be used as an adhesive in flexible packaging film industries.

The water-soluble co-polyester, wherein the polyester has a glass transition temperature above 45° C.

In an embodiment of the present invention, there is provided herein a water-soluble co-polyester as described herein, wherein the water-soluble co-polyester has a melt flow index, measured according to ASTM D 1238 at 265° C., less than 80 gm/10 min.

In an embodiment of the present invention, there is provided herein a water-soluble co-polyester as described herein, wherein the water soluble co-polyester are having in chips/pellets/Powder/flakes form.

### Quality Parameters

### Intrinsic Viscosity

Intrinsic viscosity (I.V.) is a measure of the molecular mass of the polymer and is measured by dilute solution using an Ubbelohde viscometer. All intrinsic viscosities are measured in a 60:40 mixture of phenol and s-tetrachloroethane with 0.5% concentration. The flow time of solvent and solution are checked under I.V. water bath maintained at temperature bout 25° C. The I.V., η, was obtained from the measurement of relative viscosity, ηr, for a single polymer concentration by using the Billmeyer equation:

$$IV = [ η ] = 0.25 [ ( RV - 1 ) + 3 ln RV ] / c$$

Wherein η is the intrinsic viscosity, RV is the relative viscosity; and c is the concentration of the polymeric solution (in g/dL). The relative viscosity (RV) is obtained from the ratio between the flow times of the solution (t) and the flow time of the pure solvent mixture (t0).

$$RV = nrel = Flow time of solution ( t ) / Flow time of solvant ( t 0 )$$

I.V. must be controlled so that process ability and end properties of a polymer remain in the desired range. Class ‘A’ certified burette being used for IV measurement for more accuracy.

### COOH End Groups:

The Polymer was dissolved in a mixture of phenol and chloroform (50:50 w/v) under reflux conditions. After cooling to room temperature, the COOH end groups were determined using titration against 0.025 N Benzyl alcoholic KOH solution with bromophenol blue as an indicator. Run a blank simultaneously along with sample and the final end point is at the color change from blue from yellow. COOH groups are calculated based on the below calculation and the results are expressed in meq of COOH/kg. In the equation, TR is the volume of benzyl alcoholic KOH consumed for the sample, N is the normality of benzyl alcoholic KOH, and the blank is the volume of benzyl alcoholic KOH consumed for sample solution.

$$[ ( TR - Blank ) \times N \times 1000 ] = COOH end groups ( meq / kg )$$

### Color Values

The color parameters were measured with a Hunter Lab Ultrascan VIS instrument. D65 illuminant and 10° angle is being used for color measurement. Amorphous chips were used to check by reflectance mode of Hunter color scan. Generally, the changes measured could also be seen by eye. The color of the transparent amorphous chips was categorized using the Hunter Scale (L/a/b) & CIE Scale (L*/a*/b*) values which are based on the Opponent-Color theory. This theory assumes that the receptors in the human eye perceive color as the following pairs of opposites.
L/L* scale: Light vs. Dark where a low number (0-50) indicates dark and a high number (51-100) indicates light.
a/a* scale: Red vs. Green where a positive number indicates red and a negative number indicates green.
b/b* scale: Yellow vs. Blue where a positive number indicates yellow and a negative number indicates blue.

### DSC Analysis

The Differential Scanning Calorimeter (DSC) is a thermal analyzer which can accurately and quickly determine the thermal behavior of Polymers such as glass transition temperatures (Tg), crystallization exothermic peak temperatures (Tch), peak endotherm temperatures (Tm), heats of crystallization (ΔH) and heats of fusion for all materials. A Perkin-Elmer model Jade DSC was used to monitor thermal properties of all polymer samples at heating and cooling rates of 10° C. per minute. A nitrogen purge was utilized to prevent oxidation degradation.

### DEG/EG/IPA Content:

To determine the Diethylene Glycol (DEG), Ethylene Glycol (EG), Isophthalic Acid (IPA) and Other comonomers, Polymer sample is trans-esterified with methanol in an autoclave at 200° C. for 2.5 hours with zinc acetate as a catalyst.

During methanolysis, the polymer sample is depolymerized and the liquid is filter through Whatman 42 filter paper. After filtration, 1 micro liter of the liquid was injected in Agilent Gas Chromatography (GC) under controlled GC configuration. Based on the RT (Retention Time), DEG/EG/IPA/BDO are calculated with internal standard ISTD (tetraethylene glycol dimethyl ether) and results are declared as wt %.

### Sodium Content:

To determine the Sodium content in polymer sample by wet ashing method, take 0.5 g sample and Add 10 ml of pure conc. H2SO₄ and 2 ml of conc. HNO₃. Heat above 150° C. to char. Add a mixture of 5 ml of concentrated HNO₃ and 7 ml of Perchloric acid. Heat till the solution becomes transparent. Cool it and transfer to a clean 100 ml standard flask and make up with double distilled water. It will be the Master solution. Check Sodium content of Master solution by using Microprocessor Flame photometer G-30.

Sodium content in Polymer=Reading×Make-up weight (gm)/Weight of sample (gm).

### Optical Density

Optical density is the process of transmission of light or other electromagnetic radiation by matter. The process of emission and absorption depends on the wavelength of the radiations, which includes the interaction between fundamental particles like electrons, atoms, ions, etc.

When a beam of light interacts with absorbing atoms, absorption takes place. It depends on the sample's thickness and the concentration of the absorbing atoms.

It is often said to be identical to the absorbance. It is a logarithmic ratio of the falling radiation to the transmitted radiation through a material.

For a given wavelength, the expression of optical element transmittance is expressed as:

$${Log}_{10} ( 1 / T ) ;$$

Where T is transmittance.

### Optical Density Measurement

The measurement is done at maxima of the absorbance spectra as there is the least chance of absorbance with the change in the wavelength. The measurement is a common method to quantify various important parameters like concentration of cell, production of biomass, and much more.

$$Absorbance A = - log ( I / {I}_{0} )$$

where,
I is the intensity of light that passes through the sample
I₀ is the initial light intensity.

### Optical Density of Spectrophotometer

The formula for spectrophotometer is:

$$OD = A / L$$

Where,
L=the thickness of the sample.

In other words, if a sample has an O.D. greater than 3, this means that only 1 photon of light out of 1,000 will be measured by the detector. Even with the most sophisticated instruments, this small amount of light is very hard to accurately detect above the background noise. Therefore, measurements above 3 O.D. will have greater error and will in turn be less accurate than measurements taken at a lower O.D. Thus it is always recommended to dilute samples that are >3.0 O.D. and then to factor in the dilution factor to the final measurement. This is also shown in the following graph, note how the measurement is no longer linear at high concentrations, which correspond to higher O.D. values.

### Oxygen Transmission Rate

Oxygen transmission rate Oxygen transmission rate is measured at 23° C., 0% RH, 1 atm using a MOCON Ox-Tran Model 2/21 analyzer in accordance with ASTM D 3985-05. The test specimen is held such that it separates two sides of a test chamber. One side is exposed to a nitrogen atmosphere while the other side is exposed to an oxygen atmosphere. A coulometric sensor monitoring the exit port of the nitrogen side measures the amount of oxygen present. Testing is complete when the concentration of oxygen in the nitrogen side atmosphere is constant. For a stretched sample, the film is first stretched using an Instron tensile machine. The stretched film is then held on a metallic frame to avoid film relaxation, the film-on-frame subsequently placed in the chamber to measure the oxygen transmission.

### Water Vapor Transmission Rate

Water Vapor Transmission Rate (“WVTR”, expressed as grams of water vapor transmitted per 100 square inches of film per day at a specified film thickness (mils), or g/100 in²/day) was measured in accordance with ASTM F1249-90 with a MOCON permatran model 3/33 at conditions of 100° F. (37.8° C.) and 90% relative humidity.

### EXAMPLES

### Example 1

To a 50 litre volume reactor equipped with a mechanical stirrer, a packed refluxing column, a nitrogen inlet and a heat source were added 2.43 kg of ethylene glycol, 1.2 kg 1, 6-hexanediol, 6.08 kg of terephthalic acid, 1.0 kg isophthalic acid and 2.98 g of antimony trioxide (250 ppm as antimony). Esterification was carried out at temperature of 240-260° C. under pressure up to 3.0 bars for 2-3 h. After completion of 90% esterification, the reactor was depressurized and phosphoric acid added. The pre-polymer was transferred into polycondensation reactor. Sulfonated hydroxyl terminated ester, such as bis(2-hydroxyethyl) sodium 5-sulfoisophthalate solution was added. The reaction mixture was hold for 10 min for mixing. Polycondensation reaction was carried out at temperature of 280-290° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.409 dl/g and throughput of product from reactor was more than 96% (yield).

The results of analytical parameters tested and measured are summarized in Table 1.

### Example 2

To a 50 litre volume reactor equipped with a mechanical stirrer, a packed refluxing column, a nitrogen inlet and a heat source were added 2.33 kg of ethylene glycol, 1.5 kg Diethylene glycol, 0.45 kg 2-Methyl-1, 3-propanediol, 1.2 kg Neopentyl glycol, 9.51 kg of terephthalic acid, 0.375 kg isophthalic acid, 0.3 kg Succinic acid and 4.48 g of antimony trioxide (250 ppm as antimony). Esterification was carried out at temperature of 240-260° C. under pressure up to 3.0 bars for 2-3 h. After completion of 90% esterification, the reactor was depressurized and phosphoric acid added. The pre-polymer was transferred into polycondensation reactor. Sulfonated hydroxyl terminated ester, such as bis(2-hydroxyethyl) sodium 5-sulfoisophthalate solution was added. The reaction mixture was hold for 10 min for mixing. Polycondensation reaction was carried out at temperature of 280-290° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.279 dl/g and throughput of product from reactor was more than 97.3% (yield).

### Example 3

To a 50 litre volume reactor equipped with a mechanical stirrer, a packed refluxing column, a nitrogen inlet and a heat source were added 2.08 kg of ethylene glycol, 2.25 kg 1, 4-butanediol, 2.55 kg of Neopentyl glycol, 7.75 kg of terephthalic acid, 1.8 kg isophthalic acid and 4.48 g of antimony trioxide (250 ppm as antimony). Esterification was carried out at temperature of 240-260° C. under pressure up to 1.5 bars for 2-3 h. After completion of 90% esterification, the reactor was depressurized and phosphoric acid added. Polycondensation reaction was carried out at temperature of 270-290° C. under pressure of less than 0.2 torr. After sufficient melt viscosity was achieved, polymerization was stopped and polymer cool up to 250° C. and add 2.7 kg Trimellitic anhydride and depolymerisation done under N₂ pressure till acid value reached up to 40 to 60 KOH mg/gm. Then molten polymer was cooled up to 90° C. and drain in SS tray. The intrinsic viscosity of the amorphous polymer was 0.251 dl/g and throughput of product from reactor was more than 98.1% (yield).

The results of analytical parameters tested and measured are summarized in Table 1.

### Example 4

To a 200 litre volume reactor equipped with a mechanical stirrer, a packed refluxing column, a nitrogen inlet and a heat source were added 7.33 kg of ethylene glycol, 8.0 kg Diethylene glycol, 8.0 kg 2-Methyl-1,3-propanediol, 8.0 kg Neopentyl glycol, 49.97 kg of terephthalic acid, 2.0 kg isophthalic acid, 1.6 kg Succinic acid and 23.91 g of antimony trioxide (250 ppm as antimony). Esterification was carried out at temperature of 240-260° C. under pressure up to 3.0 bars for 2-3 h. After completion of 90% esterification, the reactor was depressurized and phosphoric acid added. The pre-polymer was transferred into polycondensation reactor. Sulfonated hydroxyl terminated ester, such as bis(2-hydroxyethyl) sodium 5-sulfoisophthalate solution was added. The reaction mixture was hold for 10 min for mixing. Polycondensation reaction was carried out at temperature of 280-290° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.316 dl/g and throughput of product from reactor was more than 98% (yield).

The results of analytical parameters tested and measured are summarized in Table 1.

### Example 5

To a 50 litre volume reactor equipped with a mechanical stirrer, a packed refluxing column, a nitrogen inlet and a heat source were added 4.19 kg of ethylene glycol, 1.5 kg 1,6-hexanediol, 9.72 kg of terephthalic acid, 1.5 kg isophthalic acid, 4.48 g of antimony trioxide (250 ppm as antimony). Esterification was carried out at temperature of 240-260° C. under pressure up to 3.0 bars for 2-3 h. After completion of 90% esterification, the reactor was depressurized and phosphoric acid added. The pre-polymer was transferred into polycondensation reactor. Sulfonated hydroxyl terminated ester, such as bis(2-hydroxyethyl) sodium 5-sulfoisophthalate solution was added. The reaction mixture was hold for 10 min for mixing. Polycondensation reaction was carried out at temperature of 270-290° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.398 dl/g and throughput of product from reactor was more than 98% (yield).

The results of analytical parameters tested and measured are summarized in Table 1.

### Example 6

To a 200 litre volume reactor equipped with a mechanical stirrer, a packed refluxing column, a nitrogen inlet and a heat source were added 20.58 kg of ethylene glycol, 10.4 kg 1,6-hexanediol, 51.22 kg of terephthalic acid, 8.0 kg isophthalic acid and 23.91 g of antimony trioxide (250 ppm as antimony). Esterification was carried out at temperature of 240-260° C. under pressure up to 3.0 bars for 2-3 h. After completion of 90% esterification, the reactor was depressurized and phosphoric acid added. The pre-polymer was transferred into polycondensation reactor. Sulfonated hydroxyl terminated ester, such as bis(2-hydroxyethyl) sodium 5-sulfoisophthalate solution was added. The reaction mixture was hold for 10 min for mixing. Polycondensation reaction was carried out at temperature of 280-290° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.424 dl/g and throughput of product from reactor was more than 98.5% (yield).

The results of analytical parameters tested and measured are summarized in Table 1.

### Example 7

The procedure of Example 5 was repeated except that 15.0 wt % 1,6-hexanediol was used in place of 13% and the results are summarized in Table 1.

### Example 8

To a 200 litre volume reactor equipped with a mechanical stirrer, a packed refluxing column, a nitrogen inlet and a heat source were added 18.12 kg of ethylene glycol, 13.6 kg 1,6-hexanediol, 48.83 kg of terephthalic acid, 9.6 kg isophthalic acid and 23.91 g of antimony trioxide (250 ppm as antimony). Esterification was carried out at temperature of 240-260° C. under pressure up to 3.0 bars for 2-3 h. After completion of 90% esterification, the reactor was depressurized and phosphoric acid added. The pre-polymer was transferred into polycondensation reactor. Sulfonated hydroxyl terminated ester, such as bis(2-hydroxyethyl) sodium 5-sulfoisophthalate solution was added. The reaction mixture was hold for 10 min for mixing. Polycondensation reaction was carried out at temperature of 280-290° C. under pressure of less than 0.2 torr. After sufficient melt viscosity was achieved, polymerization was stopped. The molten polymer was cooled in the cold water and then chopped to form pellets. The intrinsic viscosity of the amorphous polymer was 0.422 dl/g and throughput of product from reactor was more than 98.5% (yield).

The results of analytical parameters tested and measured are summarized in Table 1.

### Preparation of bis(2-hydroxyethyl) sodium 5-sulfoisophthalate Monomer

The bis(2-hydroxyethyl) sodium 5-sulfoisophthalate used in herein was prepared separately as mentioned in the JP patent application 57023627 A. In a separate reactor, 45 kg of NaDMSIP and 135 kg of ethylene glycol (three times on NaDMSIP) were mixed to form a solution and 0.1 wt. % sodium acetate (with respect to NaDMSIP) was added to the solution and the solution was stirred at a temperature up to 185° C. for 90 min. The by-product, i.e., methanol was collected and then solution was kept as such for one hour at 200° C. to ensure complete conversion. The reaction mixture was allowed to cool and filtered to obtain a solid which was used as such without any further purification.

TABLE 1
The results of analytical parameters tested for examples 1-8

| Recipe | Unit | Example 1 | Example 2 | Example 3 | Example 4 | Example 5 | Example 6 | Example 7 | Example 8 |
|---|---|---|---|---|---|---|---|---|---|
| Target | kg | 10 | 15 | 15 | 80 | 15 | 80 | 80 | 80 |
| Batch wt. | | | | | | | | | |
| PTA | kgs | 6.08 | 9.51 | 7.75 | 49.97 | 9.72 | 51.22 | 51.29 | 48.83 |
| IPA | kgs | 1.0 | 0.38 | 1.8 | 2.0 | 1.5 | 8.0 | 8.0 | 9.6 |
| MEG | kgs | 2.43 | 2.33 | 2.08 | 7.33 | 4.19 | 20.58 | 20.38 | 18.12 |
| Sb₂O₃ as Sb | ppm | 250 | 250 | 250 | 250 | 250 | 250 | 250 | 250 |
| H₃PO₄ as P | ppm | 15 | 15 | 15 | 15 | 15 | 15 | 15 | 15 |
| IPA | wt. % | 10.0% | 2.5% | 12.0% | 2.5% | 10.0% | 10.0% | 10.0% | 12.0% |
| Succinic | wt. % | — | 2.0% | — | 2.0% | — | — | — | — |
| acid | | | | | | | | | |
| Trimellitic | wt. % | — | — | 18.0% | — | — | — | — | — |
| anhydride | | | | | | | | | |
| Dimethyl 5 | wt. % | 11.0% | 18.0% | — | 18.0% | 9.5% | 9.5% | 9.5% | 9.5% |
| Sulfoisophalate | | | | | | | | | |
| Sodium Salt | | | | | | | | | |
| Diethylene | wt. % | — | 10.0% | — | 10.0% | — | — | — | — |
| glycol | | | | | | | | | |
| 2-Methyl- | wt. % | — | 3.0% | — | 10.0% | — | — | — | — |
| 1,3- | | | | | | | | | |
| propanediol | | | | | | | | | |
| 1 4- | wt. % | — | — | 15.0% | | | | | |
| butanediol | | | | | | | | | |
| 1,6- | wt. % | 12.0% | — | — | — | 10.0% | 13.0% | 15.0% | 17.0% |
| Hexanediol | | | | | | | | | |
| Neopentyl | wt. % | nil | 8.0% | 17.0% | 10.0% | — | — | — | — |
| glycol | | | | | | | | | |
| Final Cut Off | | 2.2 amp. | 2.2 amp. | 2.4 amp. | 6.0 amp. | 2.2 amp. | 6.0 amp. | 6.0 amp. | 6.0 amp. |
| EI Cycle | Min | 260 min | 240 min | 235 min | 260 min | 330 min | 260 min | 265 min | 280 min |
| Time | | | | | | | | | |
| EI Peak | ° C. | 254.8 | 256.0 | 256.0 | 256.6 | 260.0 | 256.3 | 256.0 | 256.6 |
| Temp | | | | | | | | | |
| PC Cycle | Min | 110 min | 90 min | 135 min | 119 min | 77 min | 125 min | 102 min | 121 min |
| Time | | | | | | | | | |
| PC Peak | ° C. | 276.7 | 271.4 | 258.0 | 266.4 | 283.3 | 266.1 | 265.2 | 268.3 |
| Temp | | | | | | | | | |
| Parameters | | P1-2978 | P1-2983 | P1-2828 | P2-4831 | P1-3367 | P2-5663 | P2-5552 | P2-5441 |
| I.V. | Dl/g | 0.409 | 0.279 | 0.251 | 0.316 | 0.398 | 0.424 | 0.400 | 0.422 |
| —COOH | meq/Kg | 27 | 22 | 954 | 21 | 29 | 25 | 22 | 30 |
| Chips/gm | Nos | 55 | 54.0 | — | 57 | 54 | 83 | 76 | 86 |
| Color L* | | 64.0 | 35.8 | 56.8 | 62.9 | 56.8 | 62.8 | 58.2 | 60.9 |
| Color a* | | 1.1 | 0.8 | −1.0 | −1.7 | −0.1 | −0.7 | 0.0 | −0.3 |
| Color b* | | 10.4 | 5.6 | 16.2 | 10.0 | 12.1 | 6.2 | 10.1 | 8.4 |
| DEG | wt. % | 1.57 | 8.23 | 0.30 | 8.46 | 2.37 | 1.93 | 2.53 | 3.60 |
| IPA | wt. % | 9.98 | 2.30 | 12.40 | 2.40 | 9.79 | 9.99 | 9.93 | 11.74 |
| Succinic | wt. % | — | 1.6 | — | 1.93 | — | — | — | — |
| acid | | | | | | | | | |
| 2-Methyl- | wt. % | — | 1.33 | — | 8.19 | — | — | — | — |
| 1,3- | | | | | | | | | |
| propanediol | | | | | | | | | |
| 1 4- | wt. % | — | — | 11.17 | — | — | — | — | — |
| butanediol | | | | | | | | | |
| 1,6- | wt. % | 9.44 | — | — | — | 7.82 | 10.57 | 12.31 | 13.22 |
| Hexanediol | | | | | | | | | |
| Neopentyl | wt. % | — | 3.58 | 11.17 | 6.96 | — | — | — | — |
| glycol | | | | | | | | | |
| MEG | wt. % | 20.25 | 20.61 | 9.64 | 13.85 | 24.45 | 21.35 | 20.98 | 21.75 |
| Tg1 | ° C. | 53.9 | 61.5 | 52.1 | 56.3 | 55.8 | 54.9 | 50.8 | 51.0 |
| Tch1 | ° C. | ND | ND | ND | ND | ND | ND | ND | ND |
| Tm1 | ° C. | ND | ND | ND | ND | ND | ND | ND | ND |
| Delta H1 | J/g | — | — | — | — | — | — | — | — |
| Tg2 | ° C. | 61.4 | 64.5 | 50.5 | 58.3 | 58.0 | 55.1 | 53.5 | 48.7 |
| Tch2 | ° C. | ND | ND | ND | ND | ND | ND | ND | ND |
| Tm2 | ° C. | ND | ND | ND | ND | ND | ND | ND | ND |
| Delta H2 | J/g | — | — | — | — | — | — | — | — |
| MFI | g/10 | 58 | 65 | 68 | 55 | 63 | 66 | 69 | 75 |
| @260° C. | min | | | | | | | | |
| Melting | ° C. | 158.0 | 136.0 | 88.0 | 146.0 | 175.0 | 172.0 | 170.0 | 168.0 |
| point by | | | | | | | | | |
| capillary | | | | | | | | | |
| Sodium | ppm | 7853 | 12851 | — | 12851 | 6722 | 6722 | 6854 | 6771 |
| Total Yield | wt % | 98.0 | 97.3 | 98.1 | 98.3 | 98.0 | 98.5 | 98.9 | 98.5 |

### Preparation of Coating Chemical and Coating

### Example 9

Solution A:—161 g DM water was taken in a closed vessel at room temperature and heated till temperature reached to 40° C. 15.8 g Isopropyl alcohol was added at 40° C. and stirred continuously. Temperature was increased to 52° C. Added 15.8 g resin (resin made in example 1). Increased the batch temperature from 52 to 85° C. in 40 min and continuous stirred the solution. Kept the temperature up to 85° C. till the resin was completely dissolved. The reaction mixture was allowed to cooled up to maximum 30° C. and coated on A4 size film. Results are summarised in Table 2.

### Example 10

Solution A:—161 g DM water was taken in a closed vessel at room temperature and heated till the temperature was reached to 40° C. 15.8 g Isopropyl alcohol was added at 40° C., and stirred continuously. The temperature was increased to 52° C. Then 15.8 g resin (resin made in example 2) was added in the reaction mixture. The batch temperature was increased from 52 to 85° C. in 40 min and continuous stirred the solution. Kept the temperature up to 85° C. till the resin was completely dissolved. The reaction mixture was allowed to cool up to maximum 30° C. Added ETB—2.0 g in the reaction mixture. The reaction mixture was stirred for 10 min. and coated on A4 size film and results are summarised in Table 2.

### Example 11

Solution A:—161 g DM water was taken in a closed vessel at room temperature and heated till the temperature was reached to 40° C. 15.8 g Isopropyl alcohol and 2.0 ammonia solution was added at 40° C. and stirred continuously. The temperature was increased to 52° C. Then 15.8 g resin (resin made in example 3) was added in the reaction mixture. The batch temperature was increased from 52 to 85° C. in 40 min and continuous stirring the solution. Kept the temperatures up to 85° C. till the resin completely dissolved. Allowed it to cool up to max 30° C.,

Solution B:—Added IPA—1.0 g and Cymal 303—2.0 g separately in flask and stir it 10 min. Solution B mixed with Solution A and coat on A4 size film and results are summarised in Table 2.

### Example 12

Solution A:—161 g DM water was taken in a closed vessel at room temperature and heated till temperature reach to 40° C. 15.8 g Isopropyl alcohol added at 40° C. and stirred continuously. Temperature was increased to 52° and 15.8 g resin (resin made in example 3) was added. The batch temperature was increased from 52 to 85° C. in 40 min and continuously stirred till the resin was completely dissolved. The reaction mixture was allowed to cool up to max 30° C. Added ETB—4.0 g in it and stir it for 10 min.

Solution B:—Added IPA—1.0 g and Cymal 303—0.5 g separately in flask and stirred it for 10 min. Solution B was mixed with Solution A and coated on A4 size film and results are summarised in Table 2.

### Example 13

Solution A:—161 g DM water was taken in a closed vessel at room temperature and heated till temperature reached to 40° C. 15.8 g Isopropyl alcohol was added at 40° C. and stirred continuously. Temperature was increased to 52° C. and 15.8 g resin (resin made in example 4) was added to it. The batch temperature was increased from 52 to 85° C. in 40 min and continuously stirred till the resin was completely dissolved. The reaction mixture was allowed to cool up to max 30° C. Added ETB—3.5 g in it and stir it for 10 min.

Solution B:—Added IPA—1.5 g and Cymal 303—1.0 g separately in flask and stirred it for 10 min. Solution B was mixed with Solution A and coated on A4 size film and results are summarised in Table 2.

### Example 14

Solution A:—161 g DM water was taken in a closed vessel at room temperature and heated till temperature was reached to 40° C. 15.8 g Isopropyl alcohol was added at 40° C. and stirred continuously. Temperature was increased to 52° C. and 15.8 g resin (resin made in example 5) was added into it. The batch temperature was increased from 52 to 85° C. in 40 min and continuously stirred till the resin was completely dissolved. The reaction mixture was allowed to cool up to max 30° C. Added ETB—4.0 g in it and stir it for 10 min.

Solution B:—Added IPA—2.0 g and Cymal 303—2.0 g separately in flask and stirred it for 10 min. Solution B was mixed with Solution A and coated on A4 size film and results are summarised in Table 2.

### Example 15

Solution A:—161 g DM water was taken in a closed vessel at room temperature and heated till the temperature was reach to 40° C. 15.8 g Isopropyl alcohol was added at 40° C. and stirred continuously. The temperature was increased to 52° C. and 15.8 g resin (resin made in example 6) was added into it. The batch temperature was increased from 52 to 85° C. in 40 min and continuous stirred till the resin was completely dissolved. The reaction mixture was allowed to cool up to max 30° C. Added ETB—8.0 g in it and stir it for 10 min.

Solution B:—Added IPA—2.5 g and Cymal 303—2.0 g separately in flask and stirred it 10 min. Solution B was mixed with Solution A and coated on A4 size film and results are summarised in Table 2.

### Example 16

Solution A:—161 g DM was water taken in a closed vessel at room temperature and heated till temperature reached to 40° C. 15.8 g Isopropyl alcohol was added at 40° C. and stirred continuously. Temperature was increased to 52° C. and 15.8 g resin (resin made in example 7) was added into it. The batch temperature was increased from 52 to 85° C. in 40 min and continuously stirred. Kept the temperatures up to 85° C. till the resin was completely dissolved. Allowed it to cool up to max 30° C. Added ETB—10.0 g in it and stir it for 10 min.

Solution B:—Added IPA—3.0 g and Cymal 303—2.5 g separately in flask and stir it 10 min. Solution B was mixed with Solution A and coated on A4 size film and results are summarised in Table 2.

After chemical coating film exp. 9 to 16 coat with Aluminium with 2.3 to 2.7 O.D. and test Metal Adhesion (Metal to Film), Oxygen transmission rate, Water Vapor Transmission Rate and results are summarised in Table 2.

TABLE 2
Coating chemical composition and after Coating Film quality parameters tested for examples 9-16

| | | | | | | | | | |
|---|---|---|---|---|---|---|---|---|---|
| Recipe | Unit | Example 9 | Example 10 | Example 11 | Example 12 | Example 13 | Example 14 | Example 15 | Example 16 |

Solution A

| | | | | | | | | | |
|---|---|---|---|---|---|---|---|---|---|
| DM water | gm | 161.0 | 161.0 | 161.0 | 161.0 | 161.0 | 161.0 | 161.0 | 161.0 |
| Water | gm | Example 1 = | Example 2 = | Example 3 = | Example 4 = | Example 5 = | Example 6 = | Example 7 = | Example 8 = |
| Soluble | | 15.8 gm | 15.8 gm | 15.8 gm | 15.8 gm | 15.8 gm | 15.8 gm | 15.8 gm | 15.8 gm |
| Copolyester | | | | | | | | | |
| Isopropyl | gm | 15.8 | 15.8 | 15.8 | 15.8 | 15.8 | 15.8 | 15.8 | 15.8 |
| alcohol | | | | | | | | | |
| Ammonia | gm | — | — | 2.0 | — | — | — | — | — |
| solution | | | | | | | | | |
| ETB | gm | — | 2.0 | — | 4.0 | 3.5 | 4.0 | 8.0 | 10.0 |

Solution B

| Isopropyl | gm | — | — | 1.00 | 1.00 | 1.50 | 2.00 | 2.50 | 3.00 |
|---|---|---|---|---|---|---|---|---|---|
| alcohol | | | | | | | | | |
| Cymal | gm | — | — | 2.00 | 0.50 | 1.00 | 2.00 | 2.00 | 2.50 |
| 303 | | | | | | | | | |
| Parameters | | Coating Chemical and Coating Chemical Parameters | | | | | | | |
| Dissolution | % | 98% | 99% | 99.8% | 99% | 98% | 100% | 95% | 93% |
| test | | | | | | | | | |
| Solid | % | 8.0 | 8.4 | 8.3 | 8.3 | 8.4 | 8.5 | 7.8 | 7.6 |
| content | | | | | | | | | |
| pH | — | 8.0 | 8.0 | 8.0 | 8.1 | 8.2 | 8.1 | 8.1 | 8.2 |

Resin Coated A4 size Film Before Boiling

| | | | | | | | | | |
|---|---|---|---|---|---|---|---|---|---|
| Film | micron | 12.0 | 12.0 | 12.0 | 12.0 | 12.0 | 12.0 | 12.0 | 12.0 |
| thickness | | | | | | | | | |
| Haze | % | 3.5 | 3.4 | 3.5 | 3.5 | 3.2 | 3.1 | 3.4 | 3.5 |
| Clarity | % | 93.8 | 93.5 | 93.5 | 93.7 | 93.6 | 93.9 | 93.4 | 93.5 |
| Transmittance | % | 88.5 | 88.6 | 88.7 | 88.5 | 88.6 | 88.8 | 88.6 | 88.4 |
| DV | dynes/cm | 56.0 | 56.0 | 56.0 | 56.0 | 56.0 | 56.0 | 56.0 | 56.0 |
| (Surface | | | | | | | | | |
| Tension) | | | | | | | | | |
| Ink test | — | OK | OK | OK | OK | OK | OK | OK | OK |
| Dye test | — | OK | OK | OK | OK | OK | OK | OK | OK |

Resin Coated A4 size Film After Boiling-1/2 an hour

| | | | | | | | | | |
|---|---|---|---|---|---|---|---|---|---|
| DV | dynes/cm | 54-56 | 50-52 | OK | 52-54 | 54-56 | OK | 52-54 | 52-54 |
| (Surface | | | | | | | | | |
| Tension) | | | | | | | | | |
| Ink Test | — | Pass | Pass | OK | Fail | Pass | OK | Fail | Fail |
| Dye Shade | — | Pass | Fai | Pass | Pass | Pass | Pass | Pass | Pass |
| Test after | | | | | | | | | |
| Boiling | | | | | | | | | |

On Resin Coated A4 size Film, First Ink & Dye Coating Then Boiling

| | | | | | | | | | |
|---|---|---|---|---|---|---|---|---|---|
| Ink Test | — | P. Pass | Fail | P. Pass | P. Pass | P. Pass | P. Pass | P. Pass | P. Pass |
| Dye Shade | — | Dark | Light | Dark | Light | Very | Very | Dark | Dark |
| Test after | | | | | | | | | |
| Boiling | | | | | | | | | |

Metal Adhesion (Metal to film) A4 size Film

| | | | | | | | | | |
|---|---|---|---|---|---|---|---|---|---|
| Film Type | | COLM - 10 | COLM - 10 | COLM - 10 | COLM - 10 | COLM - 10 | COLM - 10 | COLM - 10 | COLM - 10 |
| Optical | Internal | 2.35-2.46 | 2.34-2.4 | 2.45-2.51 | 2.35-2.4 | 2.5-2.58 | 2.38-2.52 | 2.32-2.48 | 2.35-2.47 |
| Density | | | | | | | | | |
| (OD) | | | | | | | | | |
| Metal | gmf/25 | 550-678 | 415-794 | 856-958 | 536-788 | 602-871 | 831-907 | 688-904 | 727-899 |
| Adhesion | mm | | | | | | | | |
| (Metal to | | | | | | | | | |
| Film) | | | | | | | | | |
| WVTR @ | ASTMF- | 1.123 | 1.667 | 0.202 | 1.371 | 0.404 | 0.253 | 0.802 | 1.091 |
| ° C. 37.8, | 1249 | | | | | | | | |
| 90% RH | | | | | | | | | |
| OTR | ASTMD - | 2.355 | 3.156 | 0.429 | 2.598 | 0.937 | 0.610 | 0.929 | 2.266 |
| ASTMD @ | 3985 | | | | | | | | |
| ° C. 23, | | | | | | | | | |
| 0% RH | | | | | | | | | |

From Table 2, it can be deduced that in Example 9, 13, 15 and 16, the polymer failed in dissolution and in Example 9, 10, 12 and 13, the polymer have poor bonding strength and barrier properties. In example 11 and example 14, the polymer has very good dissolution, pass in ink test, dye test and excellent bonding strength and barrier properties.

1. A water soluble co-polyester precursor comprising:
a. at least one dicarboxylic acid or ester thereof,
b. at least one diol; and
c. at least dimethyl sulfoisophthalate (DMSIP) or isophthalic acid sulfonate (SIPA) having weight percentage in the range of 0 to 20 wt % or 0 to 18% trimellitic anhydride

2. The co-polyester precursor as claimed in claim 1, wherein said dicarboxylic acid is selected from aromatic and/or aliphatic acid the group consisting of terephthalic acid, isophthalic acid, 2,6-napthalene dicarboxylic acid, 3,4′-diphenyl ether dicarboxylic acid, hexahydrophthalic acid, 2,7-naphthalenedicarboxylic acid, phthalic acid, 4,4′-methylenebis(benzoic acid), oxalic acid, malonic acid, succinic acid, methylsuccinic acid, glutaric acid, adipic acid, 3-metyhladipic acid, pimelic acid, suberic acid, azelaic acid, sebacic acid, 1,11-undecanedicarboxylic acid, 1,10-decanedicarboxylic acid, undecanedioic acid, 1,12-dodecanedicarboxylic acid, hexadecanedioic acid, docosanedioic acid, tetracosanedioic acid, dimer acid, 1,4-cyclohexanedicarboxylic acid, 1,3-cyclohexanedicarboxylic acid, 1,1-cyclohexanediacetic acid, fumaric acid, maleic acid, and hexahydrophthalic acid.

3. The co-polyester precursor as claimed in claim 1, wherein said diol is selected from the group consisting of mono ethylene glycol (MEG), diethylene glycol, 1,3-propanediol, 1,4-butanediol, 1,6-hexanediol, 1,8-octanediol, 1,10-decanediol, 1,12-dodecanediol, 1,14-tetradecanediol, 1,16-hexadecanediol, dimer diol, (cis, trans) 1,4-cyclohexanedimethanol, di(ethylene glycol), tri(ethylene glycol), poly(ethylene ether) glycols, poly(butylene ether) glycols, branched diols, hexane diol or combinations or derivatives thereof.

4. The co-polyester precursor as claimed in claim 1, where ratio of DIMSIP/SIPA may vary 0 to 20 wt % or 0 to 18 weight % Trimellitic anhydride.

5. The co-polyester precursor as claimed in claim 1, wherein the dicarboxylic acid is terephthalic acid having 80 to 90 mol % based on the acid content.

6. The co-polyester precursor as claimed in claim 1, wherein the dicarboxylic acid is isophthalic acid having 10 to 20 mol % based on the acid content.

7. The co-polyester precursor as claimed in claim 1, wherein the diol is 1, 6 hexane diol having 20 to 25 mol % based on the diol content, and wherein the remainder diol proportion comprises said ethylene glycol.

8. The co-polyester precursor as claimed in claim 1, wherein the water soluble co-polyester has a melting point between 80 to 180° C.

9. The co-polyester precursor as claimed in claim 1, wherein the water soluble co-polyester has a glass transition temperature of above 45° C.

10. The co-polyester precursor as claimed in claim 1, wherein the water soluble co-polyester has a melt flow index, measured according to ASTM D 1238 at 265° C., less than 80 gm/10 min.

11. The co-polyester precursor as claimed in claim 1, wherein the water soluble co-polyester are in chips/pellets/Powder/flakes form.

12. The co-polyester precursor as claimed in claim 1, wherein in the water soluble co-polyester, a polymer IV can be adjusted in melt polymerization from 0.300 dl/g to 0.500 dl/gm.

13. The co-polyester precursor as claimed in claim 1, wherein the water soluble co-polyester has minimum Dv (Surface Tension) value of 56 after film coating.

14. The co-polyester precursor as claimed in claim 1, wherein a Resin Coated A4 size Film after Boiling-½ an hour pass ink test and Dye shade test is used for measuring film coating efficiency.

15. The co-polyester precursor as claimed in claim 1, wherein a Resin Coated A4 size Film, First Ink & Dye Coating Then Boiling water pass ink test and Dye shade test is used for measuring film coating efficiency.

16. The co-polyester precursor as claimed in claim 1, wherein the composition optionally comprises an additional diol selected from the group consisting of diethylene glycol 0 to 20 mol %, 0 to 25 mol % 2-Methyl-1,3-propanediol, 0 to 30 mol % Neopentyl glycol based on the diol content, wherein the remainder diol proportion comprises said ethylene glycol.

17. A film comprising the water soluble co-polyester as claimed in claim 1.
